(19) United States
(12) Patent Application Publication
(10) Pub. No.: US 2020/0189625 A1
(43) Pub. Date: Jun. 18, 2020

(54) LOCOMOTIVE WASTE HEAT RECOVERY SYSTEM AND RELATED METHODS

(71) Applicant: Claudio Filippone, College Park, MD (US)

(72) Inventor: Claudio Filippone, College Park, MD (US)

(21) Appl. No.: 16/639,733

(22) PCT Filed: Aug. 16, 2018
(86) PCT No.: PCT/US2018/046828

§ 371 Date: Feb. 17, 2020

Related U.S. Application Data
(60) Provisional application No. 62/546,548, filed on Aug. 16, 2017.

(51) Int. Cl. B61C 17/06; F02G 5/00; H02J 7/14; H02J 7/02

(52) U.S. Cl. CPC B61C 17/06; F02G 5/00; B61C 7/04; H02J 7/02; H02J 7/1423

(57) ABSTRACT

Various embodiments of a locomotive waste heat recovery system for charging an auxiliary battery, independent of the locomotive electric generator, are disclosed. The auxiliary battery is charged by a locomotive waste heat recovery system to supplement and supply the electric power normally provided by the locomotive battery during a shutdown condition caused by a locomotive auto engine start stop (AESS) system. The auxiliary battery is charged by recovery and conversion of waste thermal energy during locomotive engine operations, and its stored electric power is utilized to supply selected electrical loads during a prolonged engine shutdown condition. Accordingly, the locomotive battery can preserve its stored power to be exclusively utilized for locomotive engine start, which may decrease operational disruptions and increase the life of the locomotive battery, and thereby reducing the overall operating costs associated with the battery maintenance efforts.

This application claims priority to U.S. Provisional Application No. 62/546,548, filed Aug. 16, 2017, which is incorporated herein by reference.

### FIELD OF INVENTION

The present disclosure relates generally to systems and methods for waste heat recovery. More specifically, particular embodiments of the present disclosure relate to locomotive waste heat recovery systems (L-WHRS), and related methods, configured to charge auxiliary batteries for use in locomotives.

### DESCRIPTION OF RELATED ART

Technologies to reduce locomotive idling and pollutant emissions, while increasing fuel savings, often focus on improving fuel management through better control of fuel injection and optimizing the operational procedures for the auto engine start stop (AESS) systems. As the locomotive engine is automatically shut down during prolonged idling operations, selected locomotive electrical loads remain on to ensure vital equipment readiness (e.g., braking system) with electric power supplied by the OEM locomotive battery.

Depending on the types of operations, the locomotive crew might also load additional electrical loads onto the locomotive battery power bus (e.g., cabin air-conditioner). As a result of prolonged AESS activation, the locomotive battery may undergo deep charge and discharge cycles and rapidly become unable to perform its intended function, thus inducing operational disruptions as the locomotive engine becomes unable to start, therefore causing frequent battery replacements.

To assist potentially depleted batteries, extra boosting technologies can be used to boost the power required to re-start the locomotive engine. These technologies often involve supercapacitors or supplemental battery packs. However, as the charge-discharge cycle imposed by locomotive operations is rarely optimal for the locomotive battery, the battery life is significantly reduced even when supercapacitors and additional batteries are coupled to the locomotive battery.

Overall, the methods and technologies utilized to prolong the life-span of the locomotive batteries provide better management of the locomotive loads by shutting down battery-draining activities left on, for example, after a manual shutdown. However, as the locomotive crew can override the shutting down of battery-draining equipment, the problem of deep locomotive battery discharges and damages persists, thus inducing frequent battery replacements and disruption of operations.

Accordingly, there is a need for an improved locomotive power management system that may overcome one or more of the problems discussed above.

### SUMMARY

Therefore, various exemplary embodiments of the present disclosure may provide an improved locomotive waste heat recovery system that utilizes waste thermal energy from the locomotive engine to generate conditioned electricity to charge an auxiliary battery that may be configured to offload the locomotive battery and supply electric power to various electrical loads normally connected to the locomotive battery. The term “locomotive battery,” as used herein, may refer to an original equipment manufacturer (OEM) battery (e.g., formed of lead-acid batteries connected in various configurations) or any other battery that is functionally equivalent to the OEM battery.

Diesel-electric locomotives are equipped with combustion engines coupled to electric generators that provide propulsion electric power to traction motors and electricity to various electrical loads. The electrical loads include, for example, air conditioning system, locomotive lights, computers, transmitters, pumps, fans, compressors, and other electrical loads relating to the operation of the locomotive. When the locomotive engine is shut down, the locomotive battery can be configured to provide stored electrical energy to supply power to the engine starting system as well as to other electrical loads.

When the locomotive is idling for a predetermined period of time, an AESS system actuates a procedure resulting in the locomotive engine to shut down to reduce pollutant emissions. After the AESS system shuts down the locomotive engine, however, depending on the type of locomotive operations, certain locomotive electrical loads may be required to remain powered. Examples of such electrical loads include cabin equipment, cabin air-conditioner for locomotive personnel in stand-by, air compressor to support brakes, lights, computers, cooling pumps, and fans. Under these shutdown conditions, the locomotive battery supplies electrical power to the selected electrical loads and, as a result, is gradually discharged at a rate proportional to its capacity and the power ratings of the electrical loads it supplies.

Depending on the time duration at which the locomotive engine remains in a shutdown condition, the locomotive battery may undergo deep discharge. When the locomotive battery becomes excessively discharged, the remaining battery energy may be insufficient to start the locomotive engine and induce operational disruptions, which increase the locomotive operational costs. Furthermore, when the locomotive battery undergoes repeated deep discharges, its capacity to store electrical energy reduces and negatively impacts the battery's life-span. These operational conditions force early replacement of the locomotive battery and thereby increase equipment and operational costs.

One exemplary aspect of the present disclosure may provide an auxiliary battery formed by one or more efficient, durable, high-power, rechargeable batteries charged and operated independently of the locomotive battery. For example, the auxiliary battery can be formed by various families of rechargeable batteries with superior charge-discharge performance (i.e., high cycle durability) and capability to sustain deep discharge cycles with higher frequency when compared to the locomotive battery.

According to another exemplary aspect, the charging system for the auxiliary battery is independent of the locomotive-driven battery charging system that is normally a locomotive engine-alternator-charging system. Instead, the auxiliary battery may utilize a waste heat recovery system as the source of power for charging the auxiliary battery. For example, the waste heat recovery system may be configured to convert waste thermal energy from the locomotive engine (e.g., from the exhaust gases, engine oil, and cooling system) into electric energy, and the converted electrical energy may be used as the dedicated electric power source for recharging the auxiliary battery.

As the auxiliary battery is formed by modern high-energy density and cycle durability battery cells, a battery power management system can regulate the electric power flow in and out of the auxiliary battery and a load distribution system can selectively regulate and actuate distribution of the electrical power of the auxiliary battery to various locomotive electrical loads during locomotive engine operations with the locomotive engine at power or in a shutdown condition.

Therefore, various exemplary aspects of the present disclosure may provide a locomotive waste heat recovery system configured to convert thermal energy produced during the operation of the locomotive engine into auxiliary electric energy to be distributed to selected electrical loads and to recharge the auxiliary battery.

According to one exemplary embodiment, the converted electrical energy may be conditioned to supply power to selected electrical loads and charge the auxiliary battery to store the converted electrical energy for utilization when the locomotive engine is shut down by, for example, the AESS system and the selected electrical loads are required to remain actively powered for prolonged time periods. For example, when the locomotive engine is shut down by, for example, actuation of the AESS system, and the locomotive crew is still operating the locomotive in the cabin and/or awaiting for the locomotive to be dispatched, the locomotive waste heat recovery system of the present disclosure may switch the power source for one or more selected electrical loads from the locomotive battery to the auxiliary battery, such that the electrical energy stored in the auxiliary battery can be distributed to the selected electrical loads. As a result, the locomotive battery can be decoupled from these electrical loads during this shutdown condition, thereby preventing a substantial drainage of stored power therein during this shutdown condition.

According to another exemplary aspect, a locomotive waste heat recovery system consistent with the present disclosure may supply battery charging power to an electronic system coupled to the auxiliary battery and regulated by an auxiliary charging regulator while the locomotive engine is operating and thermal energy from the locomotive engine is converted into electricity. When the auxiliary battery is charged, and the locomotive engine is still operating at power and producing waste thermal energy, the auxiliary charging regulator, in conjunction with a load distribution system, may reconfigure the converted electric power so as to supply conditioned electrical power to various electrical loads or hotel loads. For example, as the AESS system actuates and maintains the locomotive engine in a shutdown condition, the auxiliary battery that is configured to provide adequate power rating or capacity for a desired amount of time, can supply electric power to various electrical loads for the selected amount of time, while preserving the locomotive battery, which remains adequately charged to ensure sufficient stored power to activate the engine starting circuit (e.g., a locomotive cranking system) and re-start the locomotive engine, even after prolonged engine shutdown actuated by the AESS system.

Still another exemplary aspect of the present disclosure may provide a power management system for the auxiliary battery, which is optimized to ensure that charging and discharging of the auxiliary battery is executed without overheating the auxiliary battery (e.g., lithium-ion batteries). For example, the charging and discharging operations can be optimized with the electric power ratings and voltages of the locomotive waste recovery system, such that the auxiliary battery charger actively charges the auxiliary battery when the locomotive engine is operating at power and without draining electrical supply resources from the locomotive electric alternator, and discharges the auxiliary battery to selected electrical loads when the locomotive engine is in a shutdown condition.

As the locomotive batteries are electrically connected to a series of interrupters, switches and contactors to couple and/or decouple the locomotive batteries from the locomotive electrical system, one exemplary aspect of the present disclosure may provide various configurations for distributing the electrical power supplied by the auxiliary battery to the electrical loads with safety features to prevent failures or damages to locomotive equipment as the electrical load power bus is switched from the locomotive battery to the auxiliary battery and vice versa. Switching operations to shift the electric power supply source from the locomotive battery to the auxiliary battery can be automatically executed by utilizing passive switches and interrupters as well as active, electromechanical, hydraulic or electronically controlled power modules. In some exemplary embodiments, the power modules may include switches thyristors, MOSFETs, IGBTs, as well as interrupters and electro-magnetic or pneumatically driven contactors.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several exemplary embodiments consistent with the invention and, together with the description, serve to explain the principles of the invention.

FIG. 1 is a schematic diagram of a locomotive electrical system, according to an exemplary embodiment consistent with the present disclosure.

FIG. 2 is a functional electrical diagram of the locomotive electrical system shown in FIG. 1, according to one exemplary embodiment.

FIG. 3 is a schematic diagram of a locomotive waste heat recovery system coupled to the locomotive electrical system of FIG. 1, according to one exemplary embodiment consistent with the present disclosure.

FIG. 4 is a functional electrical diagram of the locomotive waste heat recovery system and the locomotive electrical system shown in FIG. 3, according to various exemplary embodiments.

FIG. 5 is a functional electrical diagram of the locomotive waste heat recovery system and the locomotive electrical system shown in FIG. 4, illustrated with a user interface and electronic actuators for switching power supplied from the locomotive battery or the auxiliary battery, according to another exemplary embodiment.

### DESCRIPTION OF THE EMBODIMENTS

Reference will now be made in detail to the exemplary embodiments consistent with the present invention, examples of which are illustrated in the accompanying drawings. Wherever possible, the same reference numbers will be used throughout the drawings to refer to the same or like parts.

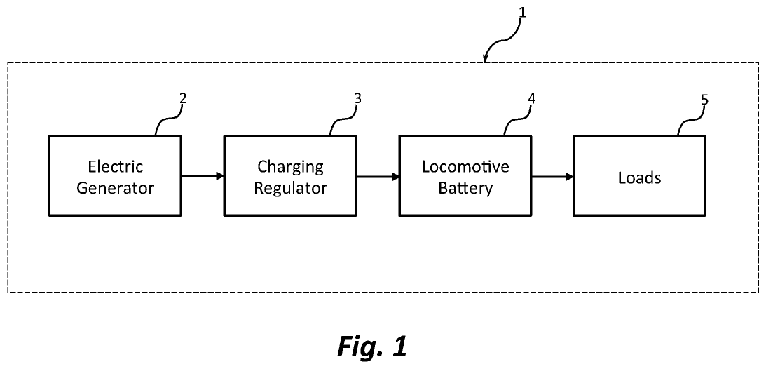

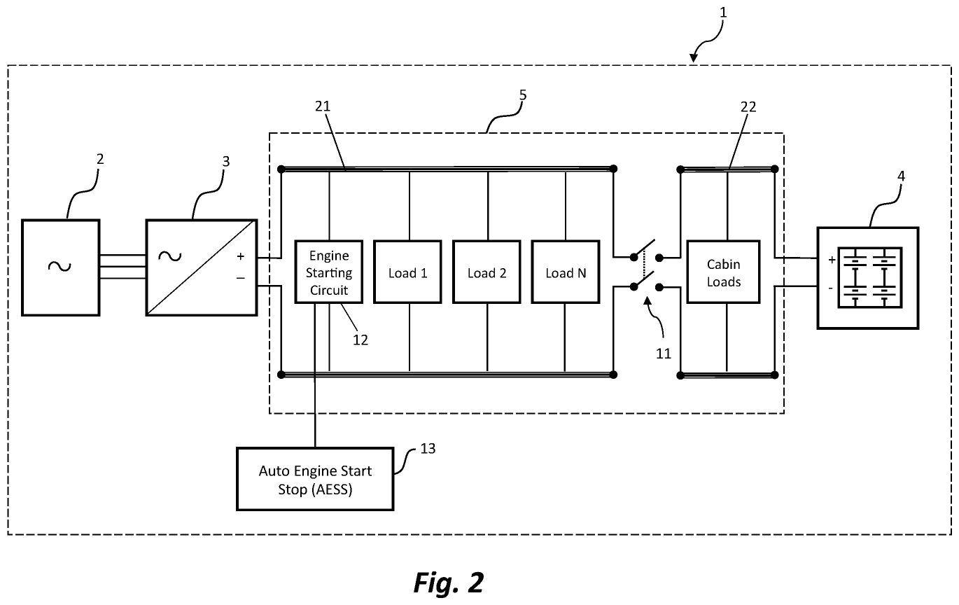

FIG. 1 is a schematic illustration of a locomotive electrical system 1 for supplying power to a locomotive battery 4 and various electrical loads 5, according to an exemplary embodiment of the present disclosure. FIG. 2 is a functional electrical diagram of the locomotive electrical system 1 of FIG. 1 with details of the locomotive power bus for supplying power to certain locomotive electrical loads and the operations of an AESS system 13.

As shown in FIGS. 1 and 2, locomotive electrical system 1 may include an electric generator 2, a charging regulator 3, locomotive battery 4, and various electrical loads 5. Locomotive electrical system 1 supplies electrical power to various locomotive electrical loads 5, such as, for example, electrical loads for supporting the combustion engine operations, electrical loads for cabin control systems, and controls to support operations of the electrical traction motors for the propulsion of the locomotive. Locomotive electrical system 1 also supplies electrical power from electric generator 2 to locomotive battery 4 for charging.

Electric generator 2 is driven by the locomotive engine and may be configured to generate multiple electric outputs at different power ratings and/or voltages. For example, electrical generator 2 may be a three-phase generator equipped with various dedicated coils with different power ratings to convert mechanical power from the locomotive engine to three-phase AC power. The AC power may then be distributed to traction motors coupled to the locomotive axles for propulsion of the locomotive, to various electrical loads and to charging regulator 3 to supply charging electric power to locomotive battery 4.

Charging regulator 3 may include a three-phase rectifier having suitable electronic equipment to rectify and condition the electric power from electric generator 2, so as to supply charging electric power at rates, voltages, and current levels that ensure adequate and safe charging of locomotive battery 4. Charging regulator 3 may be configured to satisfy the charging requirements of locomotive battery 4 to maintain battery capacity and to ensure safe and reliable performance during its life-span.

Power buses 21 and 22 are configured to distribute the electrical power from charging regulator 3 to various electrical loads 5, an engine starting circuit 12, and locomotive battery 4 via a manually- or automatically-actuated battery switch 11.

Locomotive battery 4 may be formed of multiple lead-acid battery cells connected in series and parallel to match desired voltage at the locomotive direct current (DC) power bus. The multiple lead-acid cells are connected to provide adequate power density to supply DC power at the DC locomotive bus to support various electrical loads when the locomotive is shut down by the AESS system 13.

Referring to FIG. 2, various electrical loads 5 may include various types of locomotive electrical loads. For example, various electrical loads 5 may be associated with the operation of the locomotive engine or the locomotive cabin and can be activated automatically as part of the locomotive engine operations or manually by locomotive operators.

Engine starting circuit 12 is represented as one of various electrical loads 5 (e.g., part of electrical loads 1 to N). Engine starting circuit 12 may be manually activated to start the locomotive engine or automatically activated by AESS system 13. For example, AESS system 13 may be configured to automatically shut down the locomotive engine after a prolonged period of engine idling or start the locomotive engine to, for example, prevent freezing of the locomotive cooling system.

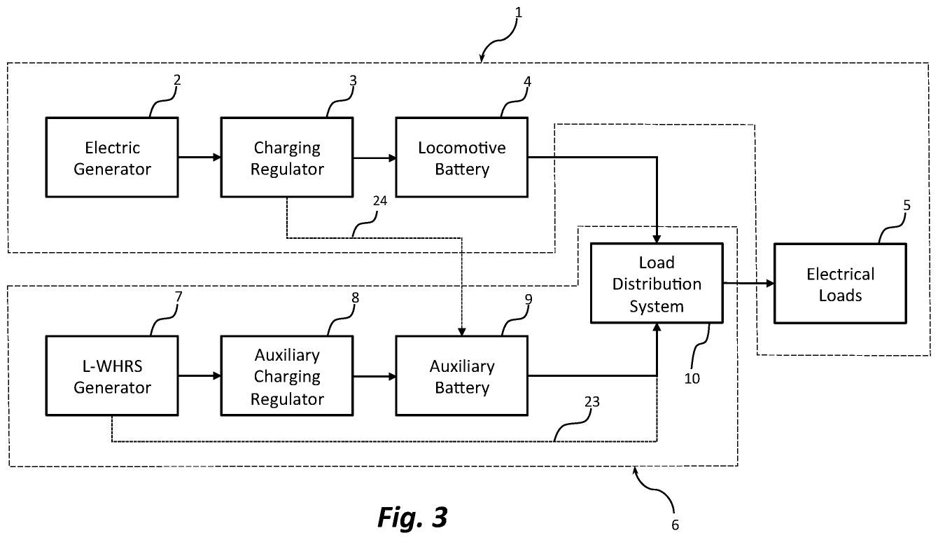

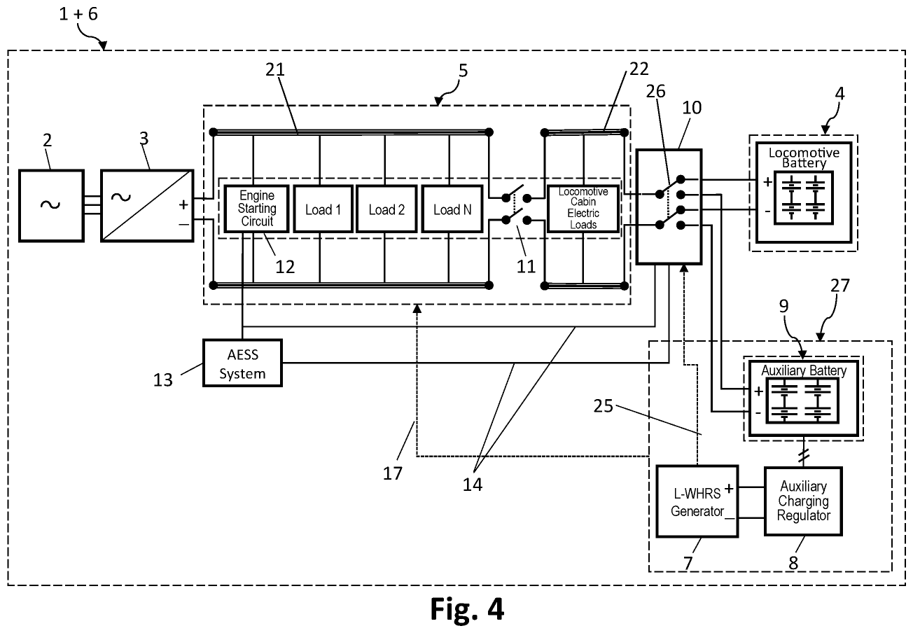

FIG. 3 is a schematic diagram of a locomotive waste heat recovery system 6 (hereinafter referred to as L-WHRS 6) coupled to a locomotive electrical system 1, according to various exemplary aspects of the present disclosure. FIG. 4 is a functional electrical diagram of L-WHRS 6 and the locomotive electrical system 1 shown in FIG. 3. L-WHRS 6 may be non-invasively integrated with locomotive electrical system 1.

L-WHRS 6 may include an electric generator 7 coupled to a waste heat recovery system (hereinafter, referred to as L-WHRS generator 7), an auxiliary charging regulator 8, an auxiliary battery 9, and a load distribution system 10. According to various exemplary embodiments, L-WHRS 6 may be configured to charge auxiliary battery 9 with electrical energy generated from L-WHRS generator 7 and distribute the electrical energy stored in auxiliary battery 9 to various electrical loads 5 through load distribution system 10.

L-WHRS 6 may be coupled to a suitable waste heat recovery system (not shown) that is configured to convert waste thermal energy from the locomotive engine to electrical energy. Examples of suitable waste heat recovery system may include, but be not limited to, the waste heat recovery systems disclosed in U.S. Pat. Nos. 6,374,613 and 9,618,273 and PCT Application Publication Nos. WO 2013/019761 A1 and WO 2016/123614, the entire disclosures of which are incorporated herein by reference.

L-WHRS generator 7 may be configured to convert the recovered energy from the locomotive engine into conditioned electric power. Thus, L-WHRS generator 7 may unload electric generator 2 as it can supply power to various electrical loads 5 whenever the locomotive engine is operating at power, thus producing waste thermal energy.

L-WHRS generator 7 may include thermal-hydraulic and electrical equipment, such as, for example, heat exchangers, balance of plant, and expanders, which are coupled to electrical generation machines and electronic inverters to condition the thermal-to-electric converted energy and controllers and to supply conditioned power to auxiliary charging regulator 8, or directly to load distribution system 10 when auxiliary battery 9 is fully charged and L-WHRS generator 7 continues to produce electric power as the locomotive engine produces waste thermal power.

Auxiliary charging regulator 8 may be configured to condition the electric power output from L-WHRS generator 7 to satisfy charging requirements of auxiliary battery 9.

Auxiliary battery 9 may include a plurality of battery cells connected in series and/or parallel. In one exemplary embodiment, auxiliary battery 9 may include one or more lithium-ion battery cells. Auxiliary battery 9 may also include a suitable auxiliary battery management system.

When the locomotive engine is shut down by, for example, activation of AESS system 13, auxiliary battery 9 continues to supply power to various electrical loads 5, such as, for example, locomotive computers system, the locomotive cooling fans and other cooling system, the locomotive cabin air-conditioning and light system, which are represented as Loads 1 to N in FIG. 4 whose power ratings are matched with the power capacity of auxiliary battery 9.

In some exemplary embodiments, L-WHRS 6 may be configured to bypass auxiliary charging regulator 8 and auxiliary battery 9 and directly supply power to load distribution system 10 via an electrical bypass 23 (FIG. 1), thereby distributing power directly to various electrical loads 5. For example, L-WHRS 6 may be configured to supply power directly to load distribution system 10 when auxiliary battery 9 is fully charged and the locomotive engine is operating at power.

According to another exemplary embodiment, auxiliary battery 9 may be configured to be charged by locomotive charging regulator 3 via an electrical line 24 (FIG. 1). This configuration may extend the capacity of locomotive battery 4. The electrical line 24 may be configured to transmit charging and/or control signals therethrough. In this configuration, the electrical energy required to charge auxiliary battery 9 is supplied by electric generator 2 (e.g., locomotive alternator). However, during the operation of the locomotive engine, the power rating of electric generator 2 might be maxed, therefore distributing additional power to auxiliary battery 9 during charging operation might not be effective or possible.

Load distribution system 10 may be configured to interface with locomotive electrical system 1 and electrical loads 5 to selectively distribute electrical power from the locomotive battery 4 or the auxiliary battery 9 to selected electrical loads 5. For example, load distribution system 10 may be configured to selectively connect and disconnect locomotive battery 4 and auxiliary battery 9 to continuously supply electrical power to selected electrical loads 5. In one exemplary embodiment, load distribution system 10 may comprise a controller configured to process electronic signals produced by AESS system 13 and signals defining status of L-WHRS generator 7, where L-WHRS generator 7 produces sufficient power to charge auxiliary battery 9 or excess power (e.g., when auxiliary battery 9 is fully charged) depending on the locomotive engine operations.

Therefore, load distribution system 10 can configure the electrical connections of power buses 21 and 22 in a manner that actuates the electric coupling of locomotive battery 4 to engine starting circuit 12 for locomotive battery 4 to supply power to the locomotive starter and start the locomotive engine, while, at the same time, managing the power supplied by auxiliary battery 9 with respect to connection to or disconnection from electrical loads 5.

For example, when the locomotive engine is operating at power and auxiliary battery 9 is fully charged or being charged by L-WHRS generator 7, selected electrical loads 5 connected to power bus 21 or 22, depending on the status of switch 11, can be configured to electrically connect, either passively or actively, to L-WHRS generator 7 to ensure the continuity of power supply to selected electrical loads 5.

Through integration of locomotive electrical system 1 with L-WHRS 6, electrical power can be continuously supplied to various electrical loads 5 (e.g., Load 1, Load 2, Load N and/or cabin electrical loads) when the locomotive engine is in a shutdown condition, which operates independently of locomotive battery 4 normally supplying power to these electrical loads 5.

With reference to FIG. 4, auxiliary battery 9 may be charged by waste thermal energy when the locomotive engine is idling or operating at power (e.g., at various notch settings) as thermal power is proportionally produced by the operation of the locomotive engine. Battery switch 11 can be manually or automatically positioned (e.g., via actuation of electro-magnetic, pneumatic, or solid-state contactors) into an on- or off-state so as to electrically connect or disconnect locomotive battery 4 from power buses 21 and 22.

Depending on the operational state of the locomotive engine (e.g., idling, operating at power, or during shutdown), auxiliary battery 9 charged by conversion of thermal energy when the locomotive engine produces waste thermal energy can be configured to supply electrical power to selected locomotive loads 5 so as to lower the electrical power supply demand on electric generator 2 and locomotive battery 4.

When the locomotive engine has been operated at power for a prolonged period of time, auxiliary battery 9 may become fully charged and the available electrical energy from L-WHRS generator 7 can be directly supplied to electrical loads 5 as a controller in load distribution system 10 can re-configure electrical actuators 26 of load distribution system 10 to transfer power directly from L-WHRS generator 7 to power buses 21, and 22 depending on the settings of battery switch 11.

In the exemplary embodiment shown in FIG. 2, load distribution system 10 is integrated with L-WHRS 6. The exemplary embodiment shown in FIG. 4 differs from that shown in FIG. 2 in that load distribution system 10 is interfaced between locomotive battery 4 and power buses 22 and 21 to supply power to electrical loads in the locomotive cabin and other electrical loads as part of electrical loads 5.

In the embodiment shown in FIG. 4, an auxiliary power supply system 27 may include auxiliary battery 9, an auxiliary battery power management system (not shown and integrated with auxiliary battery 9), auxiliary charging regulator 8, and L-WHRS generator 7. Auxiliary charging regulator 8 may switch operation from merely charging auxiliary battery 9 to supplying power to selected electrical loads 5 when auxiliary battery 9 is fully charged. Power flows from and to auxiliary battery 9, L-WHRS generator 7, and power buses 22 and 21 may be regulated via load distribution system 10.

Electrical actuators 26 may be actuated by load distribution system 10 according to the controller of load distribution system 10 and, based on signals and/or status from the auxiliary battery power management system in relation to the status of electrical loads 5, the status of AESS system 13 and the state of charge of auxiliary battery 9.

Data processing and actuation of electrical actuators 26 factor sensor signals from sensor lines 17 and 14. For example, the auxiliary battery power management system, which may include auxiliary power supply system 27, may be configured to regulate the rate of charge or discharge of auxiliary battery 9 proportionally to the type of active locomotive electrical load connected to the power bus 21 by monitoring status via sensor line 17. Similarly, when AESS system 13 is activated to shut down the locomotive engine, AESS system 13 may also provide sensor data to the controller of load distribution system 10 via auxiliary battery power management signals 14, thereby proportionally reconfiguring and optimizing the power flows into auxiliary battery 9 proportionally to the various locomotive engine operating conditions (e.g., idling, operating at power, or shutdown) and out of auxiliary battery 9 through power buses 21 and 22.

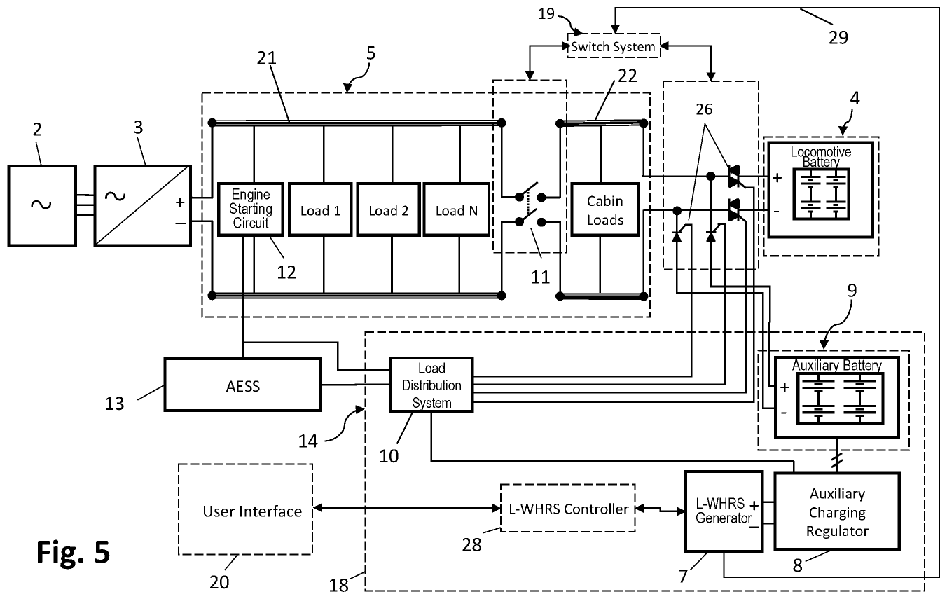

FIG. 5 is a functional electrical diagram of the locomotive electrical system 1 shown in FIGS. 1, 2 and 4, with L-WHRS system 6 integrated and interfaced to supply electric power to selected electrical loads 5 via auxiliary battery 9, according to another exemplary embodiment of the present disclosure. In this embodiment, load distribution system 10 may be interfaced with the battery management system of auxiliary battery 9 and configured to receive control signals from AESS system 13, L-WHRS controller 28, and a user interface 20 to automatically or manually activate or deactivate solid state or other types of electrical switches, respectively coupling or decoupling auxiliary battery 9 electrical loads 5, engine starting circuit 12, and the cabin electrical loads by suppling power to power buses 21 and 22 through activation of a switch system 19. Switch system 19 may be configured to ensure safe operation of power buses 21 and 22 when the electric power source is received from locomotive battery 4, auxiliary battery 9, or L-WHRS generator 7.

Switch system 19 may be configured to monitor the status of electrical actuators 26. Switch system 19 may include semiconductor/solid-state switches, electro-mechanical switches, electro-pneumatic switches, or any other types of switches and contactors. For example, in the exemplary embodiment shown in FIG. 5, the electrical actuators may include solid-state thyristors and silicon controlled rectifiers (SCRs), which can be configured to receive control or actuation signals at their gates from load distribution system 10, or L-WHRS controller 28 and the switch system 19.

Switch system 19 and L-WHRS controller 28 may ensure the power flowing in from locomotive battery 4, auxiliary battery 9, and L-WHRS generator 7 to power buses 21 and 22 is not in conflict with one another or does not cause unsafe condition since all of these power sources operate on the same electrical loads 5 and utilize the same power buses 21 and 22 for the supply of electric power. Accordingly, electrical actuators 26 may be configured to execute physical electrical interruption of connection between locomotive battery 4 and electric buses 21 and 22 via actuation of switch 11. When the locomotive engine is at power and produces sufficient waste thermal energy, L-WHRS controller 28 may actuate L-WHRS generator 7 to supply power to auxiliary battery 9 for charging auxiliary battery 9. When auxiliary battery 9 is fully charged and the locomotive engine continues to produce waste thermal energy, L-WHRS controller 28 can actuate L-WHRS generator 7 to supply power to electric bus 21, directly via switch system 19 and power line 29 or via actuation of electrical actuators 26.

When the locomotive engine is automatically shut down by AESS system 13, L-WHRS controller 28 may shut down L-WHRS generator 7 and auxiliary charging regulator 8, while reconfiguring electrical actuators 26 and switch system 19 to supply power from auxiliary battery 9 to the locomotive cabin electrical loads and electrical loads 5 connected to power buses 22 and 21, while isolating locomotive battery 4 to preserve its charge.

When the locomotive is re-started by AESS system 13 or manually by actuation of switch 11, auxiliary battery 9 may become isolated via actuation of a portion of electrical actuators 26 so as to have only one power source represented by batteries (e.g., locomotive battery 4 or auxiliary battery 9) connected to electrical loads 5.

In another exemplary embodiment, and depending on operational requirements, locomotive battery 4 and auxiliary battery 9 can be electrically configured to operate simultaneously and in parallel through actuation of switch system 19, load distribution system 10, and L-WHRS controller 28. These operations can be monitored and programmed via user interface 20. User interface 20 may provide real-time status of charge and discharge parameters, cycles, temperature and other performance parameters of auxiliary battery 9. User interface 20 may also provide real-time status of L-WHRS controller 28 along with key thermodynamic and electric parameters characterizing the operations of L-WHRS generator 7 and auxiliary charging regulator 8. The thermal-hydraulic components forming L-WHRS 6 (e.g., balance of plant, heat exchangers, expander, and L-WHRS generator 7), the battery pack forming auxiliary battery 9, and load distribution system 10 can be housed inside an enclosure 18. Enclosure 18 may protect auxiliary battery 9 and may contain potential fires or explosions caused by malfunctions of auxiliary battery 9. Enclosure 18 may also allow for the inlet and outlet of cooling or heating fluids (e.g., air) to ensure that auxiliary battery 9 is operated in agreement with the requirements and parameters monitored by the auxiliary battery power management system often integral part of integrated high-density, high-capacity lithium-ion batteries.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A battery charger system for use in a locomotive, comprising:
a waste heat recovery system configured to convert waste heat from a locomotive engine to electrical energy;
a charging regulator configured to condition the converted electric energy;
an auxiliary battery configured to receive and store the conditioned electric energy;
a load distribution system interfaced between a locomotive battery of a locomotive electrical system and an electrical load and between the auxiliary battery and the electrical load, the load distribution system being configured to selectively supply electrical power from one of the locomotive battery and the auxiliary battery to the electrical load,
wherein the load distribution system is configured to selectively connect one of the locomotive battery and the auxiliary battery to the electrical load based on a predetermined condition.

2. The battery charger system of claim 1, wherein the predetermined condition comprises an operating status of the locomotive engine, and the load distribution system is configured to disconnect the locomotive battery from the electrical load and connect the auxiliary battery to the electrical load when the locomotive engine is in a shutdown condition.

3. The battery charger system of claim 1, wherein the predetermined condition comprises an operating status of the locomotive engine, and the load distribution system is configured to connect the locomotive battery to the electrical load and disconnect the auxiliary battery from the electrical load when the locomotive engine is operating at power.

4. The battery charger system of claim 1, wherein the predetermined condition comprises an actuation of an auto engine start stop system.

5. The battery charger system of claim 1, wherein the waste heat recovery system is configured to provide the converted electrical energy directly to the load distribution system when the auxiliary battery is fully charged.

6. The battery charger system of claim 1, wherein the electrical load comprises a hotel load for a cabin of the locomotive.

7. The battery charger system of claim 1, wherein:
the electrical load comprises a first electrical load comprising a cabin electrical load and a second electrical load comprising an engine starting circuit, and
when the locomotive engine is in a shutdown condition, the load distribution system is configured to switch a first electrical connection of the first electrical load from the locomotive battery to the auxiliary battery while maintaining a second electrical connection of the second electrical load to the locomotive battery.

8. The battery charger system of claim 7, wherein the shutdown condition is caused by an actuation of an auto engine start stop system for the locomotive.

9. The battery charger system of claim 1, wherein the auxiliary battery comprises an auxiliary power management system interfaced with an auto engine start stop system.

10. A power management method for a locomotive, comprising:
charging a locomotive battery via an electrical generator of a locomotive engine when the locomotive engine is operating at power;
charging an auxiliary battery via an auxiliary generator of a waste heat recovery system when the locomotive engine is operating at power, the waste heat recovery system being configured to convert waste heat from the locomotive engine to electrical energy via the auxiliary generator;
selectively supplying electrical power from one of the locomotive battery and the auxiliary battery to an electrical load based on a predetermined condition.

11. The method of claim 10, wherein the predetermined condition comprises an operating status of the locomotive engine, and wherein selectively supplying electrical power comprises disconnecting the locomotive battery from the electrical load and connecting the auxiliary battery to the electrical load when the locomotive engine is in a shutdown condition.

12. The method of claim 10, wherein the predetermined condition comprises an operating status of the locomotive engine, and wherein selectively supplying electrical power comprises connecting the locomotive battery to the electrical load and disconnecting the auxiliary battery from the electrical load when the locomotive engine is operating at power.

13. The method of claim 10, wherein the predetermined condition comprises an actuation of an auto engine start stop system.

14. The method of claims 10, further comprising directly providing the converted electrical energy to a load distribution system for distribution to another electrical load when the auxiliary battery is fully charged.

15. The method of claims 10, wherein the electrical load comprises a hotel load for a cabin of the locomotive.

16. The method of claims 10, further comprising:
supplying electrical power from the locomotive battery to a first load comprising a cabin electrical load and a second load comprising an engine starting circuit when the locomotive engine is operating at power, and
when the locomotive engine is in a shutdown condition, switching a first electrical connection of the first electrical load from the locomotive battery to the auxiliary battery while maintaining a second electrical connection of the second electrical load to the locomotive battery.

17. The method of claims 16, wherein the shutdown condition is caused by an actuation of an auto engine start stop system for the locomotive.
